(19) United States
(12) Patent Application Publication
(10) Pub. No.: US 2007/0254083 A1
(43) Pub. Date: Nov. 1, 2007

(54) Method for Preparing Oat Husks For Xylan Production

(76) Inventors: Dirk Kahlke, Pinneberg (DE); Jurgen Puls, Reinbek (DE); Bodo Saake, Hamburg (DE)

Correspondence Address: WHITE & CASE LLP;PATENT DEPARTMENT, 1155 AVENUE OF THE AMERICAS, NEW YORK, NY, 10036, US

(21) Appl. No.: 11/572,415

(22) PCT Filed: Jul. 18, 2005
(86) PCT No.: PCT/EP05/07859

§ 371 Date: Jan. 19, 2007

(30) Foreign Application Priority Data
Jul. 19, 2004 (DE) 10 2004 034 849.9

(51) Int. Cl. B02B 3/00

(52) U.S. Cl. 426/549

(57) ABSTRACT

The invention relates to an oat husk for xylan production having the step of roughening oat husks on their surface by a roller mill, wherein the hull layer of the oat husks is partially destroyed, whereas the oat husk is essentially retained as a whole.

The present invention relates to a method for preparing oat husks for xylan production having the features of claim 1.

DE 3784919 discloses a method in which oat husks are used by leaching for producing dietetic fibers.

Oat husks are a raw material of high xylan content. They are produced in large amounts in oat mills and make up there 25 to 30% of the weight of the cereal which is processed in the mill. In the 1970s, oat husks were a main source of furfural production. The importance of this industrial branch, however, has become less after, in particular in Africa and Asia, production from rice residues has proved more expedient economically.

Currently, oat husks are used chiefly as additive to animal feed and for this are generally milled and pelleted. The price of these products, however, is low and, from economic aspects, the energy expenditure in production is additionally noticeable in adverse terms.

In recent years the interest in the use of xylan as a polymer has greatly increased. Xylans have been tested, inter alia, as gel-forming agents or thermoplastic material, but also as filler for polypropylene, as a component of paints or for coating cellulose fibers. The use of xylan can also be of interest for use in still higher-grade products, such as, for example, as a substance in tablet production, for wound care or for prevention of blood coagulation. Despite a large number of possible uses, xylan has hitherto not been available on the market in large amounts.

The object of the present invention is to supply a method for preparing oat husks for xylan production which improves the yield and quality of the product. This object is achieved by a method having the features of claim 1. Preferred embodiments are given in the subclaims.

According to the invention oat husks, to prepare them for xylan production, are charged through a roller mill and there roughened on their surface. The hull layer of the oat husks which, inter alia, contains lignin and waxes, is partially destroyed in this process, whereas the oat husk is essentially retained as a whole.

It is preferred to charge the oat husks into the roller mill at a continuous uniform volumetric flow rate in order to ensure uniform processing. The desired result is achieved, in particular, in a roller mill having fluted rolls and particularly preferably with differential roll speed.

In order to improve the quality of the product further, before the processing step in the roller mill, a sifting step can be carried out in which fines are sieved off from the oat husks. Starch particles can be removed even here, which is then achieved, however, in particular during the preparation step of the invention in the roller mill and in the resieving preferably carried out subsequently.

A plant for carrying out a preferred embodiment of the method of the invention has, for example, four stations. In a presiever, fines and also starch particles therein are separated from the oat husks which can be charged directly from a mill. The oat husks thus treated are transported by means of a metering unit into a roller mill at a continuous uniform volumetric flow rate. After the oat husks have been roughened there on their surface and the hull layer of the oat husk has partially been destroyed, the oat husk, however, is essentially retained as a whole, and is fed to a resieving where again fines and in particular starch particles are removed. The oat husks thus prepared can then be fed to a xylan production method.

To test the advantageous action of the mechanical pretreatment, extractions of husks with and without mechanical pretreatment were carried out.

The reference material without mechanical pretreatment was freed from starch impurities as far as possible by washing with hot water (“reference”). No washing was carried out on the mechanically pretreated husks.

The action of the pretreatment will be documented on the basis of two examples.

### EXAMPLE 1

Both husk materials were extracted with 5% strength NaOH at 90° C. and 10% consistency for 1 h. The extract was pressed off over a sieve using a hydraulic press. The resultant residue was then rewashed with water and dried. The filtrate was neutralized with acetic acid, precipitated in three times the amount of ethanol and separated off by filtration. The resultant arabinoxylan was again suspended in water (corresponding to the starting volume). The pH was set to 4 and the arabinoxylan again precipitated in ethanol, filtered off and dried.

Extraction and workup of the extracts were carried out repeatedly to determine the experimental variation.

TABLE 1
Comparison of the yields and composition of the
powder produced from the unpressurized extraction of
pretreated husks and reference husks

| | | | Polysaccharides | | |
|---|---|---|---|---|---|
| | Powder | | Arabin- | | |
| Sample | yield | Lignin | oxylan | Glucan | Others |
| Reference | 41.5 ± 2.3 | 5.6 | 30.2 | 4.8 | 0.8 |
| husks | | | | | |
| Pretreated | 40.4 ± 0.4 | 4.5 | 34.3 | 0.6 | 0.9 |
| husks | | | | | |

% of raw material (oat husks)

The mechanical pretreatment considerably improves the reproducibility of the extractions. As a result the process is easier to control.

In addition, the selectivity of the extraction is considerably improved by the pretreatment. The resultant arabinoxylan has a significantly lower lignin fraction and especially a considerably lower glucan content. The glucan reduction is chiefly due to marked reduction of the starch impurities.

TABLE 2
Comparison of the yields and lignin content of
the extraction residues from the unpressurized
extraction of pretreated husks and reference husks

| Sample | Yield | Lignin content % |
|---|---|---|
| Reference husks | 41.3 | 4.9 |
| Pretreated husks | 41.7 | 3.5 |

% of raw material (oat husks)

The husk residues obtained after extraction likewise display a significantly lower lignin content for the material from the process having mechanical pretreatment. As a result further refining of the residue by removing the lignin in bleaching reactions is significantly promoted.

### EXAMPLE 2

Both husk materials were repeatedly extracted with 5% strength NaOH at 90° C. and 10% consistency for 1 h. In the reaction, the reactor was charged with 0.6 MPa O₂ so that during the extraction the conditions of an alkaline oxygen bleaching were simultaneously met. Further workup was performed in a similar manner to Example 1.

TABLE 3
Comparison of the yields and composition of the
powder produced from the combined bleaching and
extraction of pretreated husks and reference husks

| | | | Polysaccharides | | |
|---|---|---|---|---|---|
| | | | Arabin- | | |
| Sample | Yield | Lignin | oxylan | Glucan | Others |
| Reference | 39.6 ± 1.5 | 5.6 | 28.8 | 4.4 | 0.8 |
| husks | | | | | |
| Pretreated | 39.0 ± 0.3 | 3.6 | 33.7 | 0.8 | 1.0 |
| husks | | | | | |

% of raw material (oat husks)

The mechanical pretreatment also considerably improved the reproducibility of the extractions under these extraction conditions. The selectivity of the extraction is likewise again improved, so that the lignin content and the starch impurities are markedly reduced when compared with the reference sample.

The resultant arabinoxylan again has a significantly lower lignin fraction and a considerably lower glucan content.

TABLE 4
Comparison of the yields and lignin content of
the extraction residues from the combined bleaching and
extraction of pretreated husks and reference husks

| Sample | Yield | Lignin content |
|---|---|---|
| Reference husks | 39.4 | 3.4 |
| Pretreated husks | 41.4 | 2.5 |

% of raw material (oat husks)

After the combined bleaching and extraction, the resultant husk residues also show a significantly lower lignin content for the material from the process having mechanical pretreatment.

The main advantages of the described mechanical pretreatment can therefore be summarized as follows:
improvement of reproducibility and thus controllability of the extraction,
increase in the selectivity by reducing the lignin content and the starch content in the resultant arabinoxylan,
decrease of the lignin content in the remaining extraction residue and thus an improvement of the utilization potential of the residue in particular in processes which appear to make bleaching of the residue desirable.

1. A method for preparing oat husks for xylan production having the step of roughening oat husks on their surface by a roller mill having fluted rolls with differential roll speed, wherein the hull layer of the oat husks is partially destroyed, whereas the oat husk is essentially retained as a whole.

2. (canceled)

3. The method of claim 1 wherein the oat husks are fed into the roller mill at a continuous uniform volumetric flow rate.

4. The method of claim 1 wherein before the oat husks are fed through the roller mill, fines are sieved from the oat husks.

5. The method of claim 1 wherein after the oat husks have been fed through the roller mill, fines are sieved off.
